(19) United States
(12) Patent Application Publication
(10) Pub. No.: US 2022/0201382 A1
(43) Pub. Date: Jun. 23, 2022

(54) AUDIO HEADSET POSITION DETECTION

(71) Applicant: Hewlett-Packard Development Company, L.P.

(72) Inventors: Te-Yueh Lin, Taipei City (TW); Wei Jen Chen, Taipei City (TW); Chien Chung Chien, Taipei City (TW)

(73) Assignee: Hewlett-Packard Development Company, L.P., Spring, TX (US)

(21) Appl. No.: 17/599,593

(22) PCT Filed: Jul. 24, 2019
(86) PCT No.: PCT/US2019/043268

§ 371 Date: Sep. 29, 2021

(51) Int. Cl. H04R 1/10; G06F 3/16; H04R 5/033; H04R 5/04

(52) U.S. Cl. CPC H04R 1/1041; H04R 1/1008; H04R 5/04; H04R 5/033; G06F 3/165

(57) ABSTRACT

Aspects of the present disclosure are directed to sensing earpiece positioning relative to user's left and right ears, and to routing audio signals based on the positioning. As may be implemented with various examples, for respective earpieces that generate audible sound, positions of opposing regions of one of the earpieces are detected relative to an ear, in which the opposing regions are along a perimeter of one of the earpieces. A sensor signal indicative of the detected positions is communicated, and audio signals of respective channels are routed to the earpieces, based on the sensor signal.

### BACKGROUND

Audio headsets are utilized in a variety of applications, including from listening to music, to listening to audio while watching videos, conversing via telephone, noise cancellation, and a variety of other industrial and recreational uses. Many such headphones include earpieces tailored for a right side ear or a left side ear.

### BRIEF DESCRIPTION OF FIGURES

Various examples may be more completely understood in consideration of the following detailed description in connection with the accompanying drawings, in which:

FIGS. 1A and 1B show front and side views of an example earpiece with sensor circuitry, in accordance with the present disclosure;

FIG. 2 shows a front view of an example over-the-ear headset, in accordance with the present disclosure;

FIG. 3 shows a front view of an example on-the-ear headset, in accordance with the present disclosure; and

FIG. 4 shows an example data flow diagram for assessing headset orientation and setting headset functions accordingly, in accordance with the present disclosure.

While various examples discussed herein are amenable to modifications and alternative forms, aspects thereof have been shown by way of example in the drawings and will be described in detail. It should be understood, however, that the intention is not to limit the disclosure to the particular examples described. On the contrary, the intention is to cover all modifications, equivalents, and alternatives falling within the scope of the disclosure including aspects defined in the claims. In addition, the tem′ “example” as used throughout this application is by way of illustration, and not limitation.

### DETAILED DESCRIPTION

Aspects of the present disclosure are applicable to a variety of different systems and methods involving audio headsets and, in particular, setting right and left ear orientation for such headsets. In certain non-limiting examples, aspects of the present disclosure may involve sensor circuitry that facilitates detection of headset positioning relative to a user's left or right ear. Such detected positioning may then be used to route respective audio channel signals, as may pertain to a left and to a right channel, to an appropriate one of a user's left or right ear. In these contexts, the sensor circuitry may utilize distance-based measurement to ascertain distances between different portions of the headset and the user's ear, in which the respective distances may be used to determine whether the ear is a right ear or a left ear. For instance, a longer distance may be used to indicate positioning at a front side of the user's ear.

Certain specific examples involve earpieces having sensors near front and back portions of a pad or cushion that rests against the ear. Each earpiece is designed to engage with an ear, in which a distance between the earpiece and the ear to which it is engaged is greater at the front side of the ear, relative to the backside of the ear. By detecting distances from the sensors to the ear, it may be determined which sensor is located near the front side of the ear and, therein, whether the ear is a right ear or a left ear.

Various examples involve headsets having left and right earpieces that are connected to one another by a bridge designed to span over the top of a user's head. Such examples may involve an on-the-ear earpiece or an over-the-ear earpiece, in which a pad or other component rests on or nearly on the user's ear. Sensors are located in or on the earpiece at opposing lateral sides thereof, which face forward or rearward on a user's head, depending on which side the headset is placed on.

Functions related to sensor circuitry as characterized herein may be carried out in various locations, such as within a sensor chip placed on or in an earpiece, elsewhere in the earpiece or in a headset of which the earpiece is a part, or at an audio source such as in a portable device coupled directly or wirelessly to a headset. Similarly, routing of audio signals in accordance with detected earpiece positioning may be carried out at the headset or remotely at an audio source, based on detected positioning of earpieces to which the audio signals are routed.

In accordance with an example, an apparatus includes a headset having first and second earpieces that generate audible sound, as well as sensor circuitry and audio routing circuitry. The sensor circuitry detects positions of opposing regions of one of the earpieces relative to an ear, with the opposing regions being along a perimeter of one of the earpieces, and communicates a sensor signal indicative of the detected positions. The audio routing circuitry routes audio signals of a first audio channel to the first earpiece and routes audio signals of a second audio channel that is different than the first audio channel to the second earpiece, based on the sensor signal.

The sensor circuitry may, for example, include a first sensor coupled to one of the opposing regions and a second sensor coupled to the other one of the opposing regions, in which the sensors respectively align to front and back edges of the ear. The respective sensors may provide the sensor signal indicative of a distance between the sensor and the ear. The sensors may provide differential signal indicative of a difference between respective distances detected by each sensor, therein indicating which of a right ear and a left ear to which the one of the earpieces is engaged with. For instance, it has been recognized that, when worn, a region of an earpiece near the front of the user's ear tends to be further away from the ear than the region of the earpiece near the rear of the user's ear. Thus, by detecting which of the two sensors (when aligned laterally at front/back positions of the ear) exhibits a greater distance, it may be determined that this sensor exhibiting the greater distance is on the forward/front side of the ear. This may then be used to determine which ear the earpiece is engaged with.

The first and second earpieces may engage with and deliver the audible sound to a user's right and left ears, such as when a user places the headset on his or her head. The sensor circuitry is connected to one of the earpieces, detects whether that earpiece is engaged with the right ear or the left ear, and communicates a sensor signal with data indicative of which ear the one of the earpieces is engaged with. This data may, for example, include distance data characterizing how far opposing front and rear portions of the earpiece are from the user's ear. The audio routing circuitry routes audio signals of an audio channel for a right ear to one of the earpieces engaged with the right ear, and routes audio signals of an audio channel for a left ear to one of the earpieces engaged with the left ear, based on the data indicative of which ear the one of the earpieces is engaged with.

In some instances, sensor circuitry includes a first sensor circuit coupled to one of the opposing regions and a second sensor circuit coupled to the other one of the opposing regions. Each sensor circuit detects a distance to the ear that the earpiece is engaged with, and communicates an output indicative of which ear the one of the earpieces is engaged with based on the detected distance. For instance, the sensor circuitry may detect whether the earpiece is engaged with the right ear or the left ear by detecting a distance between one of the sensor circuits corresponding to a distance to a front of the ear. The headset may, when in use on an ear, align opposing regions of one of the earpieces to front and back regions of the ears such that the first sensor circuit is positioned on a front region of the ear when the one of the earpieces is engaged with the left ear, and the second sensor circuit is positioned on a front region of the ear when the one of the earpieces is engaged with the right ear. The sensor circuitry detects that the earpiece is on the left ear when the distance to the ear indicated by the first sensor is longer than the distance indicated by the second sensor, and detects that the earpiece is on the right ear in response to the second sensor indicating a distance to the ear that is longer than the distance indicated by the first sensor circuit. In these and other examples, the sensor may provide data indicative of which ear the one of the earpieces is engaged with by providing a differential signal indicative of a difference between respective distanced detected by the sensor circuits.

Headsets characterized above may be implemented as an over-the-ear headset or an on-the-ear headset. In such an over-the-ear headset, each earpiece may have a pad along a perimeter and that encircles a perimeter of the ear when worn, with the opposing regions being in or on the pad. Respective sensors are coupled to different ones of the opposing regions, aligned to a front and back edge of the ear. In such an on-the-ear headset, each earpiece has a pad along a perimeter of the earpiece that rests upon an outer surface of a perimeter of the ear, when worn, with the opposing regions being in or on the pad. Respective sensors are similarly coupled to different ones of the opposing regions of the pad, and respectively align to front and back edges of the outer surface of the perimeter of the ear.

Various example methods may be carried out for assessing the positioning of earpieces. In certain examples involving a headset having first and second earpieces to generate audible sound, positions of opposing regions along a perimeter of an earpiece are detected relative to an ear. A sensor signal indicative of the detected positions is generated, and audio signals of first and second audio channels are respectively routed to different ones of the first and second earpiece, based on the sensor signal. The sensor circuits may be aligned to front and back edges of the ear and used to detect the positions of the opposing regions of the earpiece.

In certain examples, the method further includes engaging the earpieces respectively with a user's right and left ears, and detecting whether one of the earpieces is engaged with the right or left ear using sensor circuitry connected to the earpiece. The sensor signal is communicated with data indicative of which ear the one of the earpieces is engaged with. Based on such data, audio signals of a right audio channel are routed to the earpiece engaged with the right ear, and audio signals of a left audio channel are routed to earpiece engaged with the left ear.

The sensor circuitry may be utilized with a first sensor coupled to one of the opposing regions and a second sensor coupled to the other one of the opposing regions. Each sensor circuit is used for detecting a distance to the ear to which the earpiece bearing the sensor circuits is engaged, and data indicative of which ear the one of the earpieces is engaged with is provided based on the detected distance. In this context, the sensor circuitry may be utilized to detect whether the one of the earpieces is engaged with the right ear or the left ear by detecting a distance between one of the sensor circuits corresponding to a distance to a front of the ear. The sensor circuitry may be used to provide a differential signal indicative of a difference between respective distanced detected by the sensor circuits.

In a more specific example when the headset is used on an ear, the opposing regions of one of the earpieces are aligned to front and back regions of the ears such that the first sensor circuit is positioned on a front region of the ears when the one of the earpieces is engaged with the left ear, and the second sensor circuit is positioned on a front region of the ears when the one of the earpieces is engaged with the right ear. Accordingly, the sensor circuitry may be used to detect that the one of the earpieces is on the left ear in response to the first sensor circuit indicating a longer distance to the ear than indicated by the second sensor circuit, and that the earpiece is on the right ear in response to the second sensor circuit indicating a longer distance to the ear than indicated by the first sensor circuit.

Another example is directed to an apparatus having first and second earpieces to generate and deliver audible sound to a user's left and right ears, along with sensor circuitry that detects a distance to one of the user's ears to which the first earpiece is engaged and communicates a signal indicative of the detected distance. The sensor circuitry may include first and second sensors located at laterally opposing sides of the first earpiece, that respectively detect distances to the user's ear. The apparatus further includes audio routing circuitry that detects which of the user's left and right ears the first earpiece is engaged with based on the distances detected by the sensors. If the first earpiece is detected as being engaged with the user's left ear, a left audio signal is routed to the first earpiece and a right audio signal is routed to the second earpiece. If the first earpiece is engaged with the user's right ear, a right audio signal is routed to the first earpiece and a left audio signal is routed to the second earpiece. In a particular example, the first earpiece aligns, when engaged with the user's left ear, the first sensor with a front of the user's left ear and the second sensor with a back of the user's left ear. When engaged with the user's right ear, the first earpiece aligns the first sensor with a front of the user's right ear and aligns the second sensor with a back of the user's right ear.

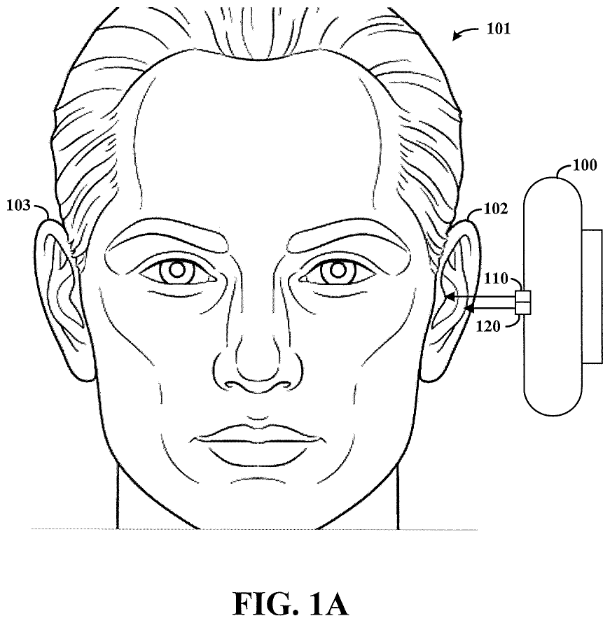

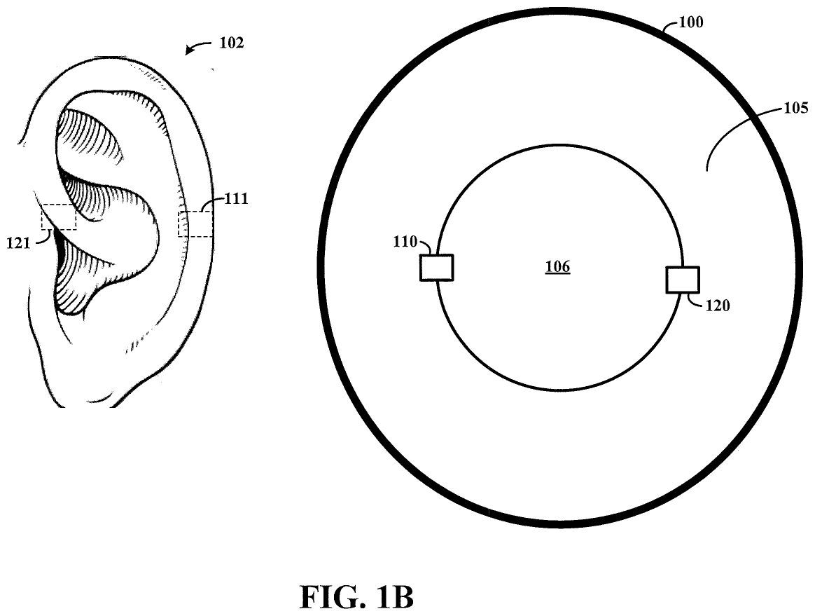

Turning now to the figures, FIGS. 1A and 1B show front and side views of an earpiece 100 with sensor circuitry, in accordance with the present disclosure. The earpiece 100 is shown prior to engagement with a user 101, at a left ear. When the earpiece is positioned on the left ear of the user's head, respective sensors 110 and 120 detect distance to the user's ear at the locations shown by arrows in FIG. 1A.

Referring to FIG. 1B, an inside view of the earpiece 100 is shown, with a pad region 105 extending around a perimeter of the earpiece, and sensors 110 and 120 positioned along an inner circumference of the perimeter pad. Audible sound is generated and passed from a central region 106. When the inner side of the earpiece 100 is positioned on ear 102, the sensors 110 and 120 are positioned adjacent the regions 111 and 121 respectively as shown with dashed lines in FIG. 1B.

Each sensor 110 and 120 detects the distance to these regions of the ear (when worn and engaged with the ear). The distance from the sensor 120 to the portion of the ear at 121 is greater than the distance from the sensor 110 to the portion of the ear at 111. Accordingly, it may be detected that the earpiece 100 is being worn on the left ear 102. Were the inner side of earpiece 100 placed on the user's right ear, the distance from sensor 110 to the user's ear would be greater than the distance from sensor 120 to the user's ear, and as such it may be detected that the earpiece is on the right ear.

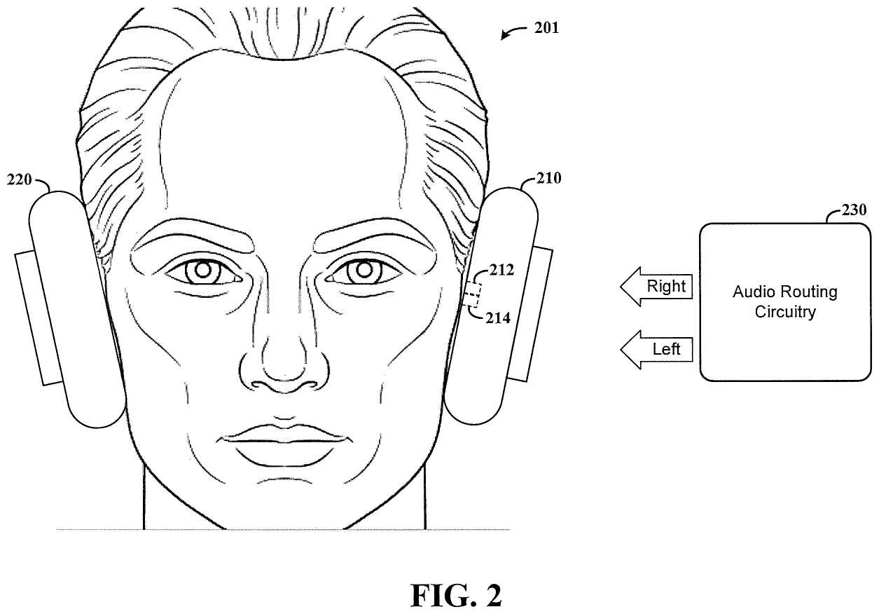

FIG. 2 shows a front view of an over-the-ear headset, show by way of example as engaged with a user 201, in accordance with the present disclosure. The headset includes earpieces 210 and 220, which may be placed on either left or right ears. Referring to earpiece 210, sensors 212 and 214 are located within the earpiece and offset laterally front and back, as shown. These sensors 212 and 214 may, for example, be implemented in a manner similar to the sensors 110 and 120 shown in FIGS. 1A and 1B, for detecting positioning relative to an ear 102.

Audio routing circuitry 230 routes right and left audio signals to the earpieces 210 and 220, based on distances sensed by sensors 212 and 214. In some implementations, the audio routing circuitry 230 also operates as an audio source, such as by providing audio signals of local or streamed audio. By way of example, the earpiece 210 is shown located on the user's left ear as shown with sensor 212 being near the front (frontward facing) side of the earpiece and the sensor 214 being near the back (rearward facing) side of the earpiece. As may be implemented consistently with examples above, the audio routing circuitry 230 may detect that the earpiece 210 is engaged with the user's left ear in response to a signal from the sensors 212 and 214 indicating that the sensor 212 is further away from the user's ear than the sensor 214. In response to detecting this positioning, a right side audio signal is routed to earpiece 220 and a left side audio signal is routed to earpiece 210.

If the earpiece 210 is engaged with the user's right ear, the sensor 212 is then located near the rear of the user's right ear and the sensor 214 is located near the front of the user's right ear. The audio routing circuitry 230 may detect that the earpiece 210 is engaged with the user's right ear in response to a signal from the sensors 212 and 214 indicating that sensor 212 is further away from the ear than the sensor 214. Accordingly, right side audio signals are routed to earpiece 210 and left side audio signals are routed to earpiece 220.

The audio routing circuitry 230 may be implemented in a variety of manners. As an example, the audio routing circuitry 230 may be implemented in a mobile telephone, tablet or other device that generates audio signals for listening. These signals may be routed to the earpieces 210 and 220 wirelessly, or by direct wire. As another example, the audio routing circuitry 230 may be implemented in the earpiece 210, in which the audio routing circuitry directs left and right audio signals accordingly, including sending an appropriate audio signal via wired or wireless connection to the earpiece 220. For instance, both right and left audio signals may be provided from an audio source such as a mobile telephone to the earpiece 210, which then routes the signals internally or to earpiece 220, based on the sensors 212 and 214. Routing may include, for example, utilizing a comparator to determine which of the sensors 212 and 214 provides a signal indicative of greater distance, and related switches with logic circuitry that switches left and right audio signals to the proper earpiece.

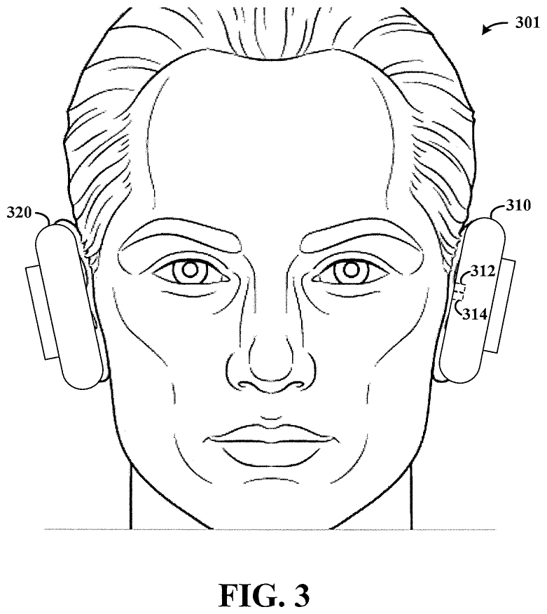

FIG. 3 shows a front view of an on-the-ear headset engaged with a user 301, in accordance with the present disclosure. The headset includes earpieces 310 and 320, and sensors 312 and 314 integrated with earpiece 310. The sensors 312 and 314 detect distance to the user's ear with which the earpiece 310 is engaged, in a manner similar to that described above in connection with earpiece 210 and sensors 212 and 214. As such, further discussion of such detection and related signal routing is omitted for brevity. The sensors 312 and 314 are positioned within the earpiece 310 so that the respective distances detected by each sensor will reflect a greater distance for the one of the sensors located nearer the front of the user's ear, relative to the other sensor. Such positioning may be similar to the positions 111 and 121 shown in FIG. 1B.

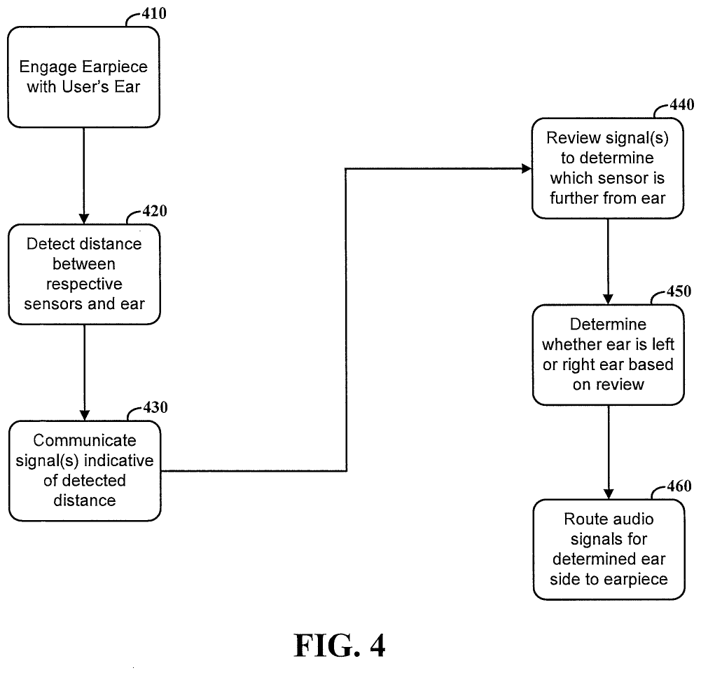

FIG. 4 shows a data flow diagram for assessing headset orientation and setting headset functions accordingly, in accordance with the present disclosure. At block 410, an earpiece is engaged with a user's ear, and a distance between respective sensors in the earpiece and the ear is detected at block 420. This may involve, for example, detecting distance from a sensor located near a front side of the earpiece relative to its placement on the user's ear, and from a sensor located near a rear side of the earpiece as so placed, and may be implemented with an earpiece such as that shown in the other figures. At block 430, a signal or signals indicative of the detected distance are communicated, and the signal or signals are reviewed at block 440 to determine which sensor is further from the ear. The signal or signals may be reviewed, for example by comparing signals from each sensor to determine which signal represents a larger distance. Where one signal is communicated, for example as a signal obtained to represent subtraction of one sensor value from the other sensor value, the sign of the value (positive or negative) may be utilized to determine which sensor indicates a greater distance to the ear.

Once the signals have been reviewed, a determination is made at block 450 as to whether the ear is a left ear or right ear, based on the review. This determination may be made, for example, by determining that the sensor at the greater distance is aligned to a front side of the user's ear, and using a known placement of the respective sensors in the earpiece. For instance, when implementing this activity at block 450 in connection with the earpiece in FIG. 1B, it is determined that the earpiece is on a user's right ear in response to sensor 110 indicating a greater distance, and it is determined that the earpiece is on the user's left ear in response to sensor 120 indicating a greater distance. At block 460, audio signals for the determined ear side are routed to the earpiece. For instance, if the earpiece is determined as being on the user's left ear, a left audio signal may be routed to the earpiece, and a right audio signal may be routed to a corresponding earpiece (which may be determined as being on the user's right ear).

Terms referring to orientation, such as in referring to front and back or opposing sides of an earpiece, or to left or right ears, may be used herein to refer to relative positions of elements as shown in the figures. Similarly, detecting distance to a front or back of an ear may be relative to placement. It should be understood that the terminology is used for notational convenience and that in actual use the disclosed structures may be oriented in a manner that is different from the orientation shown in the figures. Thus, the terms should not be construed in a limiting manner.

Based upon the above discussion and illustrations, various modifications and changes may be made to the various examples without strictly following those illustrated and described herein. For example, methods as shown in the Figures may involve actions carried out in various orders, with aspects herein retained, or may involve fewer or more actions. Functions related to sensor circuitry as characterized herein may be carried out in locations other than those described, such as within a sensor circuit or at a remote location such as an audio source. Various noted examples may be combined, such as by combining aspects of the processes shown in FIG. 3 with one another and/or with componentry as depicted in the other figures. Such modifications do not depart from the true spirit and scope of various aspects of the disclosure, including aspects set forth in the claims.

What is claimed is:

1. An apparatus comprising:
a headset having first and second earpieces to generate audible sound;
sensor circuitry to:
detect positions of opposing regions of one of the earpieces relative to an ear, the opposing regions being along a perimeter of one of the earpieces, and
communicate a sensor signal indicative of the detected positions; and
audio routing circuitry to route audio signals of a first audio channel to the first earpiece and to route audio signals of a second audio channel that is different than the first audio channel to the second earpiece, based on the sensor signal.

2. The apparatus of claim 1, wherein:
the first and second earpieces are to engage with and deliver the audible sound to a user's right and left ears;
the sensor circuitry is connected to one of the earpieces and is to detect whether the one of the earpieces is engaged with the right ear or the left ear, and is to communicate the sensor signal with data indicative of which ear the one of the earpieces is engaged with; and
the audio routing circuitry is to, based on the data indicative of which ear the one of the earpieces is engaged with,
route audio signals of an audio channel for a right ear to one of the earpieces engaged with the right ear, and
route audio signals of an audio channel for a left ear to one of the earpieces engaged with the left ear.

3. The apparatus of claim 2, wherein the sensor circuitry includes a first sensor circuit coupled to one of the opposing regions and a second sensor circuit coupled to the other one of the opposing regions, each sensor circuit to detect a distance to the ear to which the one of the earpieces is engaged, and to provide the data indicative of which ear the one of the earpieces is engaged with based on the detected distance.

4. The apparatus of claim 3, wherein the sensor circuitry is to detect whether the one of the earpieces is engaged with the right ear or the left ear by detecting a distance between one of the sensor circuits corresponding to a distance to a front of the ear.

5. The apparatus of claim 3, wherein
the headset is to, when in use on an ear, align the opposing regions of the one of the earpieces to front and back regions of the ears such that:
the first sensor circuit is positioned on a front region of the ears when the one of the earpieces is engaged with the left ear, and
the second sensor circuit is positioned on a front region of the ears when the one of the earpieces is engaged with the right ear, and
the sensor circuitry is to detect that the one of the earpieces is:
on the left ear in response to the first sensor circuit indicating a longer distance to the ear than indicated by the second sensor circuit, and
on the right ear in response to the second sensor circuit indicating a longer distance to the ear than indicated by the first sensor circuit.

6. The apparatus of claim 3, wherein the sensor circuitry is to provide the data indicative of which ear the one of the earpieces is engaged with by providing a differential signal indicative of a difference between respective distanced detected by the sensor circuits.

7. The apparatus of claim 1, wherein the sensor circuitry includes a first sensor circuit coupled to one of the opposing regions and a second sensor circuit coupled to the other one of the opposing regions, the sensor circuits to respectively align to a front edge and to a back edge of the ear.

8. The apparatus of claim 1, wherein
the headset is an over-the-ear headset, each earpiece having a pad along a perimeter of the earpiece to encircle a perimeter of the ear, the opposing regions being in the pad, and
the sensor circuitry includes a first sensor circuit coupled to one of the opposing regions and a second sensor circuit coupled to the other one of the opposing regions, the sensor circuits to respectively align to a front edge and to a back edge of the ear.

9. The apparatus of claim 1, wherein
the headset is an on-the-ear headset, each earpiece having a pad along a perimeter of the earpiece to rest upon an outer surface of a perimeter of the ear, the opposing regions being in the pad, and
the sensor circuitry includes a first sensor circuit coupled to one of the opposing regions and a second sensor circuit coupled to the other one of the opposing regions, the sensor circuits to respectively align to a front edge and to a back edge of the outer surface of the perimeter of the ear.

10. The apparatus of claim 1, wherein the sensor circuitry includes a first sensor circuit coupled to one of the opposing regions and a second sensor circuit coupled to the other one of the opposing regions, the sensor circuits to respectively align to a front edge and to a back edge of the ear and to provide the sensor signal indicative of a distance between the sensor and the ear.

11. The apparatus of claim 1, wherein the sensor circuitry is to provide the sensor signal indicative of the detected positions by providing a differential signal indicative of a difference between respective distances detected by the sensor circuits, and therein indicating which of a right ear and a left ear to which the one of the earpieces is engaged with.

12. A method comprising:
for a headset having first and second earpieces to generate audible sound, detecting positions of opposing regions an earpiece relative to an ear, the opposing regions being along a perimeter of the earpiece;
communicating a sensor signal indicative of the detected positions; and
routing audio signals of a first audio channel to the first earpiece, and routing audio signals of a second audio channel that is different than the first audio channel to the second earpiece, based on the sensor signal.

13. The method of claim 12, further including:
engaging the first and second earpieces with a user's right and left ears;
using sensor circuitry including first and second sensor circuits connected to one of the earpieces, detecting whether the one of the earpieces is engaged with the right ear or the left ear, and communicating the sensor signal with data indicative of which ear the one of the earpieces is engaged with; and
based on the data indicative of which ear the one of the earpieces is engaged with,
route audio signals of an audio channel for a right ear to one of the earpieces engaged with the right ear, and
route audio signals of an audio channel for a left ear to one of the earpieces engaged with the left ear.

14. The method of claim 13, further including,
aligning the opposing regions of the one of the earpieces to front and back regions of the ears such that:
the first sensor circuit is positioned on a front region of the ears when the one of the earpieces is engaged with the left ear, and
the second sensor circuit is positioned on a front region of the ears when the one of the earpieces is engaged with the right ear;
using the sensor circuitry with a first sensor circuit coupled to one of the opposing regions and a second sensor circuit coupled to the other one of the opposing regions, detecting with each sensor circuit a distance to the ear to which the one of the earpieces is engaged, and detecting that the one of the earpieces is:
on the left ear in response to the first sensor circuit indicating a longer distance to the ear than indicated by the second sensor circuit, and
on the right ear in response to the second sensor circuit indicating a longer distance to the ear than indicated by the first sensor circuit; and
providing the data indicative of which ear the one of the earpieces is engaged with based on the detected distance.

15. An apparatus comprising:
first and second earpieces to generate and deliver audible sound to a user's left and right ears;
sensor circuitry including first and second sensors located at laterally opposing sides of the first earpiece, each sensor to detect a distance to one of the user's ears to which the first earpiece is engaged, and to communicate a signal indicative of the detected distance; and
audio routing circuitry to:
detect which of the user's left and right ears the first earpiece is engaged with based on the distances detected by the first and second sensors including a relatively shorter distance being indicative of a rear portion of the one of the user's ears to which the first earpiece is engaged,
in response to detecting that the first earpiece is engaged with the user's left ear, route a left audio signal to the first earpiece and route a right audio signal to the second earpiece, and
in response to detecting that the first earpiece is engaged with the user's right ear, route a right audio signal to the first earpiece and route a left audio signal to the second earpiece.
